(19) United States
(12) Patent Application Publication
(10) Pub. No.: US 2026/0050563 A1
(43) Pub. Date: Feb. 19, 2026

(54) PROCESSOR HARDWARE PACKAGING AND ARCHITECTURE AWARE INTERRUPT ROUTING

(71) Applicant: QUALCOMM Incorporated, San Diego, CA (US)

(72) Inventors: Dinesh Kumar CHOUDHARY, Tonk (IN); Philip Geoffrey DERRIN, Beecroft (AU)

(21) Appl. No.: 18/802,780

(22) Filed: Aug. 13, 2024

(51) Int. Cl. G06F 13/24; G06F 13/38

(52) U.S. Cl. CPC G06F 13/24; G06F 13/385

(57) ABSTRACT

A method for processor hardware packaging and architecture aware interrupt routing is described. The method includes detecting a shared peripheral interrupt. The method also includes determining an interrupt routing mode associated with the shared peripheral interrupt. The method further includes issuing the shared peripheral interrupt to a targeted package if package routing is detected as the interrupt routing mode.

### BACKGROUND

### Field

Aspects of the present disclosure relate to semiconductor devices and, more particularly, to processor hardware packaging and architecture aware interrupt routing.

### Background

Modern-day processors are equipped with multiple cores, which range from efficient, in-order-execution to super/hyper scalar architectures. The number of cores in modern-day processors has steadily risen from single (modem), dual/quad cores systems in mobile processors to an expanded number of processor cores in server compute-platforms. A system-on-chip (SoC) may include multiple processor cores/processor clusters for executing real-world applications. These real-world applications drive the complexity of SoCs due to an ever-increasing demand for additional numbers of processor cores/processor clusters for meeting performance benchmarks.

During operation, some of the processor cores/processor clusters of an SoC are under constant utilization while executing real-world applications, and others of the processor cores/processor clusters are underutilized while executing the code of these real-world applications. As a result, efficient interrupt routing management in SoCs becomes more important. Otherwise, a specific set of processor cores/processor clusters may wear out. These worn-out processor cores/processor clusters cause power and performance issues, and eventually result in system issues. Processor hardware packaging and architecture aware interrupt routing is desired.

### SUMMARY

A method for processor hardware packaging and architecture aware interrupt routing is described. The method includes detecting a shared peripheral interrupt. The method also includes determining an interrupt routing mode associated with the shared peripheral interrupt. The method further includes issuing the shared peripheral interrupt to a targeted package if package routing is detected as the interrupt routing mode.

An apparatus including at least one memory and at least one processor is described. The at least one processor is coupled to the at least one memory. The at least one processor configured to detect a shared peripheral interrupt. The at least one processor is also configured to determine an interrupt routing mode associated with the shared peripheral interrupt. The at least one processor is further configured to issue the shared peripheral interrupt to a targeted package if package routing is detected as the interrupt routing mode.

This has outlined, broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-chip (SoC), which is configured for processor hardware packaging and architecture aware interrupt routing, in accordance with various aspects of the present disclosure.

FIG. 2 is a circuit diagram illustrating a hardware packaging central processing unit (CPU) subsystem (CPUSS) of the system-on-chip (SoC) of FIG. 1, including an interrupt controller to support processor hardware packaging aware interrupt routing, according to various aspects of the present disclosure.

FIG. 3 is a block diagram further illustrating heterogenous architecture cores of the system-on-chip (SoC) of FIG. 2, including an interrupt controller to support processor hardware architecture aware interrupt routing, according to various aspects of the present disclosure.

FIG. 4 is a process flow diagram illustrating processor hardware packaging and architecture aware interrupt routing, according to various aspects of the present disclosure.

FIG. 5 is a process flow diagram illustrating a method for processor hardware packaging and architecture aware interrupt routing, according to various aspects of the present disclosure.

FIG. 6 is a block diagram showing an exemplary wireless communications system in which a configuration of the disclosure may be advantageously employed.

FIG. 7 is a block diagram illustrating a design workstation used for circuit, layout, and logic design of the processor hardware packaging and architecture aware interrupt routing disclosed herein.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form to avoid obscuring such concepts.

As described herein, the use of the term “and/or” is intended to represent an “inclusive OR,” and the use of the term “or” is intended to represent an “exclusive OR.” As described herein, the term “exemplary” used throughout this description means “serving as an example, instance, or illustration,” and should not necessarily be construed as preferred or advantageous over other exemplary configurations. As described herein, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described herein, the term “proximate” used throughout this description means “adjacent, very near, next to, or close to.” As described herein, the term “on” used throughout this description means “directly on” in some configurations, and “indirectly on” in other configurations. It will be understood that the term “layer” includes film and is not construed as indicating a vertical or horizontal thickness unless otherwise stated. As described, the term “substrate” may refer to a substrate of a diced wafer or may refer to a substrate of a wafer that is not diced. Similarly, the terms “chip” and “die” may be used interchangeably.

Modern-day processors are equipped with multiple cores, which range from efficient, in-order-execution to super/hyper scalar architectures. The number of cores in these modern-day processors has steadily risen from approximately eight (8) processor cores in mobile processors to ninety-six (96) processor cores in server compute-platforms. A system-on-chip (SoC) may include multiple processor cores/processor clusters executing real-world applications. Real-world applications drive the complexity of SoCs due to an ever-increasing demand for additional numbers of processor cores/processor clusters for meeting performance benchmarks.

During operation, some of the processor cores/processor clusters of an SoC are under constant utilization while executing real-world applications. Unfortunately, others of the processor cores/processor clusters of the SoC are underutilized while executing the code of these real-world applications. As a result, efficient interrupt routing management in these SoCs becomes more important. Without efficient interrupt routing management, a specific set of processor cores/processor clusters may wear out. These worn-out processor cores/processor clusters cause power and performance issues and eventually result in SoC processor core/processor cluster operation issues.

Conventional interrupt routing algorithms either target interrupts to a specific core or target interrupts by considering whether a core is currently in an idle state, an efficiency class, or in an enabled/disabled state. Conventional interrupt routing algorithms, however, do not support hardware packaging awareness or architecture awareness. Although a hardware architecture allocates multiple interrupts specific to a package, hardware interrupts may be delivered inefficiently based on either a targeted core or a system current dynamic state. Processor hardware packaging and architecture aware interrupt routing is desired.

Various aspects of the present disclosure are directed to processor hardware packaging and architecture aware interrupt routing. The processor hardware packaging and architecture aware interrupt routing may utilize awareness of where an interrupt can be directed to a specific package (e.g., cluster). According to various aspects of the present disclosure, interrupt routing is further randomized and distributed within a package/cluster's cores instead of being limited to targeting a specific core. These aspects of the present disclosure propose additional routing algorithms to target the interrupt on a specific package containing processors. The routing improvement considers the processors within a specific package by building upon existing mechanisms like enabled/disabled state, efficiency class, or current idle state.

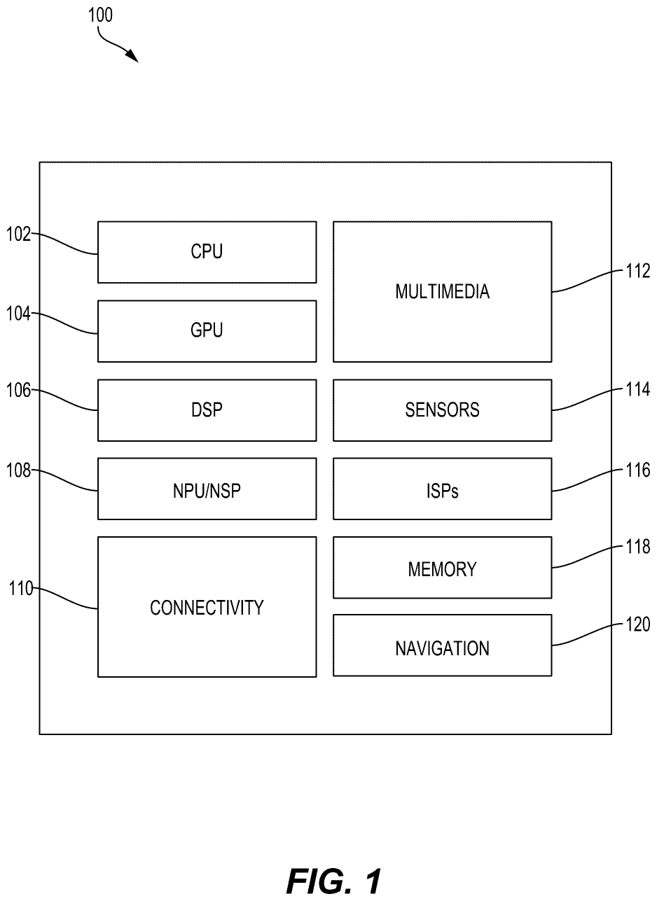

FIG. 1 illustrates an example implementation of a host system-on-chip (SoC) 100, which is configured for processor hardware packaging and architecture aware interrupt routing, in accordance with aspects of the present disclosure. The host SoC 100 includes processing blocks tailored to specific functions, such as a connectivity block 110. The connectivity block 110 may include sixth generation (6G), connectivity fifth generation (5G) new radio (NR) connectivity, fourth generation long term evolution (4G LTE) connectivity, Wi-Fi connectivity, USB connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU)/neural signal processor (NSP) 108. The host SoC 100 may also include a sensor processor 114, image signal processors (ISPs) 116, a navigation module 120, which may include a global positioning system, and a memory 118. The multi-core CPU 102, the GPU 104, the DSP 106, the NPU/NSP 108, and the multimedia engine 112 support various functions such as video, audio, graphics, gaming, artificial networks, and the like. Each processor core of the multi-core CPU 102 may be a reduced instruction set computing (RISC) machine, RISC-V, an advanced RISC machine (ARM), a microprocessor, or any reduced instruction set computing (RISC) architecture. The NPU/NSP 108 may be based on an ARM instruction set.

The multi-core CPU 102 is equipped with multiple cores, which may range from efficient, in-order-execution to super/hyper scalar architectures. The number of cores in the multi-core CPU 102 may range from eight (8) processor cores in a mobile processor implementation to ninety-six (96) processor cores in a server compute-platform implementation of the host SoC 100. The SoC 100 may include multiple processor cores/processor clusters executing real-world applications. The real-world applications drive the complexity of the SoC 100 due to an ever-increasing demand for additional numbers of processor cores/processor clusters for meeting performance benchmarks.

During operation, some of the processor cores/processor clusters of the SoC 100 are under constant utilization while executing real-world applications. Unfortunately, others of the processor cores/processor clusters of the SoC 100 are underutilized while executing the code of the real-world applications. As a result, efficient interrupt routing management in the SoC 100 becomes much more important. Without efficient interrupt routing management, a specific set of processor cores/processor clusters of the SoC 100 may wear out. The worn-out processor cores/processor clusters cause power and performance issues and eventually result in processor core/processor cluster operation issues for the SoC 100.

Conventional interrupt routing algorithms either target interrupts to a specific core or target interrupts by considering whether a core is currently in an idle state, an efficiency class, or in an enabled/disabled state. Conventional interrupt routing algorithms, however, do not support hardware packaging awareness or architecture awareness. Although a hardware architecture allocates multiple interrupts specific to a package, hardware interrupts may be delivered inefficiently based on either a targeted core or a system current dynamic state. Processor hardware packaging and architecture aware interrupt routing is desired.

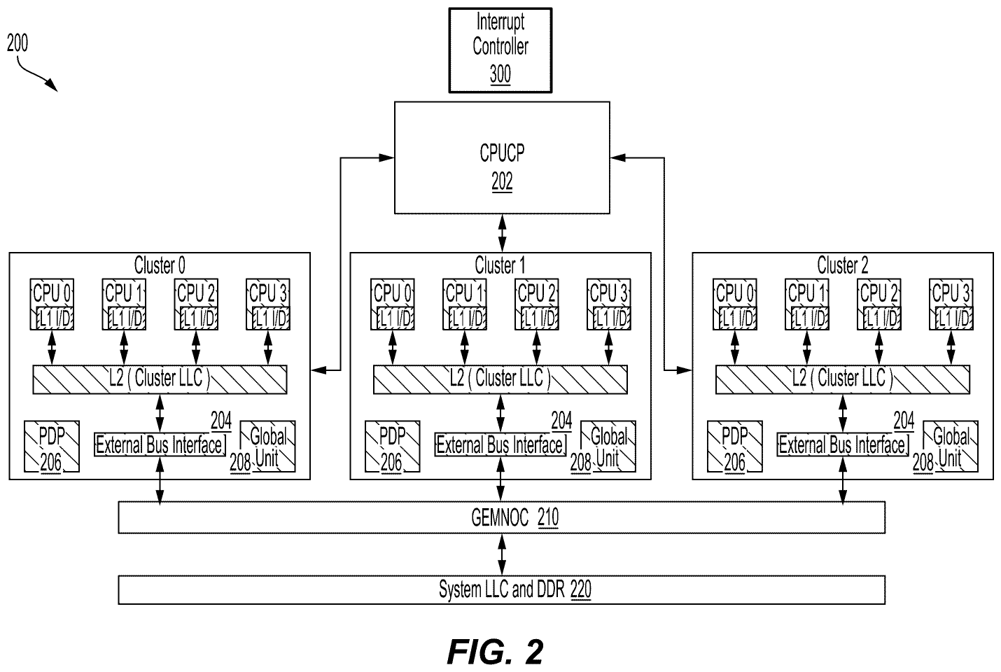

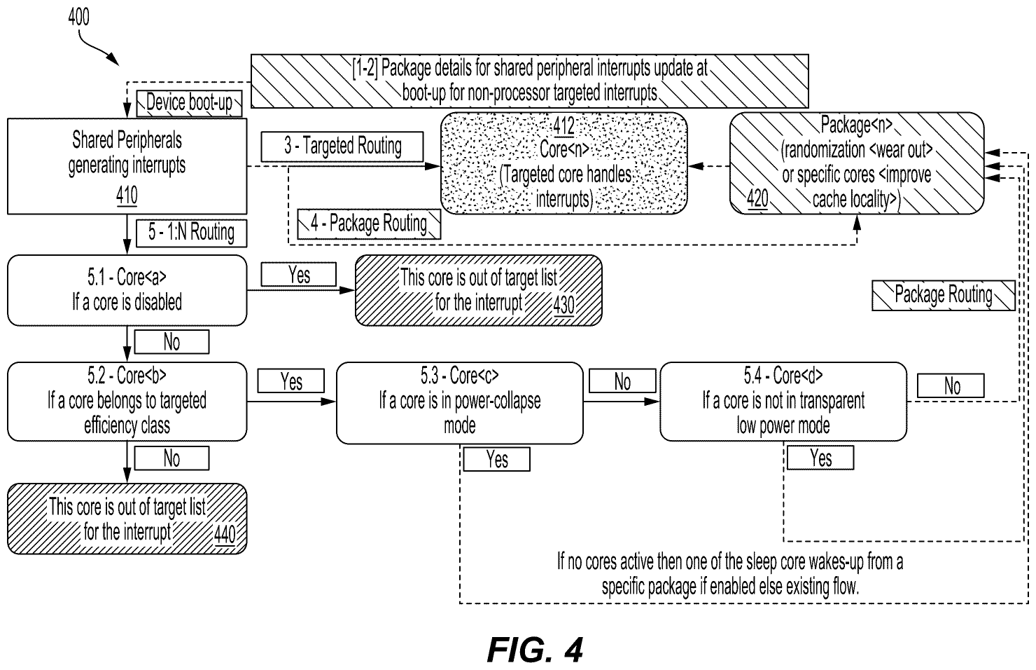

FIG. 2 is a circuit diagram illustrating a hardware packaging central processing unit (CPU) subsystem (CPUSS) 200, for example, of the system-on-chip (SoC) of FIG. 1, including an interrupt controller 300 to support processor hardware packaging aware interrupt routing, according to various aspects of the present disclosure. As shown in FIG. 2, the CPUSS 200 includes a CPUSS control processor (CPUCP) 202 of CPU clusters (e.g., Cluster 0, Cluster 1, Cluster 2). In this implementation, each CPU cluster includes a set of four CPUs (e.g., CPU0, CPU1, CPU2, CPU3). Other implementations may include a different number of CPUs. According to various aspects of the present disclosure, the CPUSS 200 includes the interrupt controller 300 configured for processor hardware packaging and architecture aware interrupt routing, as further described in FIG. 4.

As further illustrated in FIG. 2, each CPU cluster includes a large dedicated per-cluster last level cache (LLC) (e.g., L2 (Cluster LLC)) coupled to an external bus interface 204. Additionally, each CPU cluster includes a power and debug management processor (PDP) 206 and a global unit 208 configured to manage CPU hardware (e.g., phase locked loops (PLLs), a power controller, etc.) as well as multiple hardware trackers. In various aspects of the present disclosure, the global unit 208 manages a single PLL for the set of CPUs and the cluster LLC of each CPU cluster. Additionally, a network-on-chip (NoC) 210 provides a fabric and coherence point for each CPU cluster to access a system memory 220 (e.g., system LLC and double-data-rate (DDR) memory).

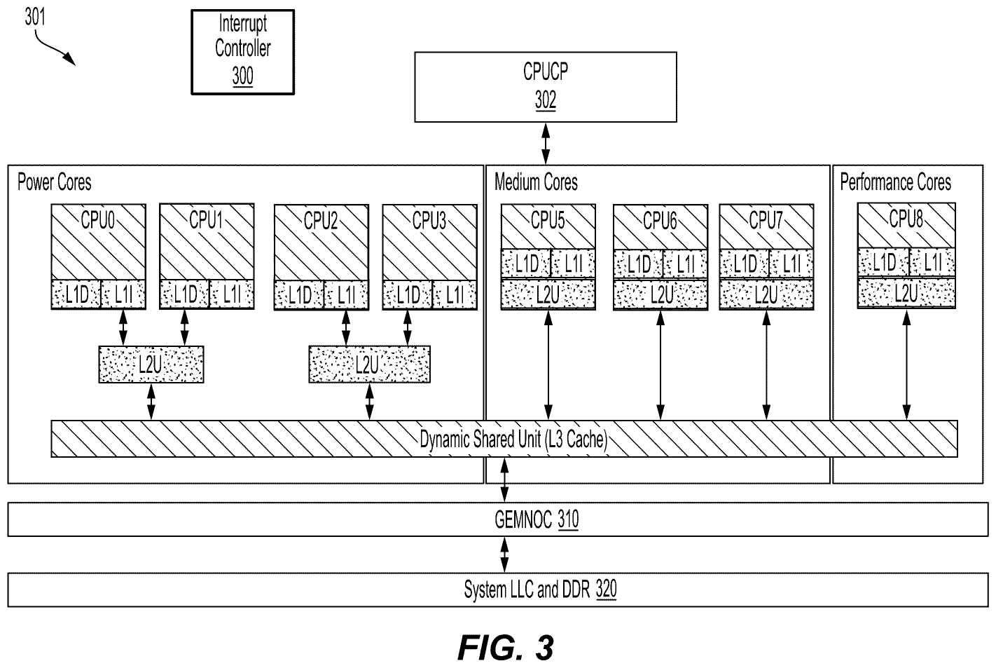

FIG. 3 is a block diagram further illustrating heterogenous architecture cores of the system-on-chip (SoC) of FIG. 2, including an interrupt controller 300 to support processor hardware architecture aware interrupt routing, according to various aspects of the present disclosure. As shown in FIG. 3, a central processing unit (CPU) subsystem (CPUSS) 301 includes a CPUSS control processor (CPUCP) 302 of eight (8) CPUs (e.g., CPU0, CPU1, CPU2, CPU3, CPU5, CPU6, CPU7, CPU8) assigned to either a power core, a medium core, or a performance core). In this implementation, the power core is assigned four (4) CPUs (e.g., CPU0, CPU1, CPU2, CPU3), the medium core is assigned three (3) CPUs (e.g., CPU5, CPU6, CPU7), and the performance core is assigned one (1) CPU. In other implementations, the CPUSS 301 may include a different number of CPUs as well as different core assignments.

As further illustrated in FIG. 3, each CPU includes a level one data (L1D) cache and a level two instruction (L2) cache coupled to a level two (L2) unified (L2U) cache. In this example, the power core operates according to a separate frequency source and shares an L2U cache between CPU0 and CPU1 and an L2U cache between CPU2 and CPU3 as well as a voltage domain with a level three (L3) cache. The CPUs of the medium core and the performance core include a dedicated L2U cache to directly access the L3 cache (e.g., a dynamic shared unit). Additionally, the CPUs of the medium core and the performance core operate according to separate frequency sources but share a voltage domain.

In various aspects of the present disclosure, a network-on-chip (NoC) 310 provides a fabric and coherence point for access to a system memory 320 (e.g., system LLC and double-data-rate (DDR) memory). According to various aspects of the present disclosure, the CPUSS 301 includes the interrupt controller 300 configured for processor hardware packaging and architecture aware interrupt routing, as further described in FIG. 4.

Various aspects of the present disclosure are directed to configuring the interrupt controller 300 to utilize the awareness of where an interrupt can be assigned to a specific package (e.g., cluster), for example, as shown in FIGS. 2 and 3. According to various aspects of the present disclosure, interrupt routing of the interrupt controller 300 is further randomized and distributed within a package/cluster's cores instead of being limited to targeting a specific core. These aspects of the present disclosure propose additional routing algorithms for enabling the interrupt controller 300 to target interrupt specific packages containing processors. The routing improvement of the interrupt controller 300 considers the processors within a specific package that builds upon existing mechanisms like enabled/disabled state, efficiency class, or current idle state.

In some implementations, an interrupt controller enhancement for the interrupt controller 300 supports targeted routing. Conventionally, interrupt routing modes are limited to either a targeted processor routing mode or a 1:N interrupt routing mode (e.g., Interrupt_Routing_Mode-0x1-→targeted processor, 0→1:N). In various aspects of the present disclosure, a bit width encoding of the interrupt routing mode expands beyond a single bit. In some implementations, the interrupt routing mode expands to support additional routing modes beyond the targeted processor routing mode and the 1:N interrupt routing mode (e.g., Interrupt_Routing_Mode-0x1→targeted processor, 0x2→targeted package, 0x3→reserved, and 0x0→1:N). The interrupt controller enhancement is further illustrated in FIG. 4.

FIG. 4 is a process flow diagram 400 illustrating processor hardware packaging and architecture aware interrupt routing, according to various aspects of the present disclosure. As shown in the process flow diagram 400, steps 1-2 execute during device boot-up, in which package details for shared peripheral interrupts (SPIs) are updated for non-processor targeted interrupts. In various aspects of the present of the present disclosure, this process includes storing package configuration information for the SPIs in a configuration register space at boot-up. As shown at block 410, an SPI is generated. At step 3, an interrupt routing mode of an issued SPI is generated as targeted routing. At block 412, a targeted core (Core<n>) manages the issued SPI. Otherwise, at step 4, the interrupt routing mode of the issued SPI is identified as package routing.

According to various aspects of the present disclosure, at step 4, the interrupt routing mode is identified as targeted to a specific package according to a package specific interrupt routing mode. In response, the interrupt is delivered to a processor within a package at block 420. At block 420, dynamic recommendations are performed in response to the interrupt, such as randomization to assign the interrupt to a specific core to prevent wear out. Additionally, the interrupt may be assigned to specific cores for improving cache locality. For example, as shown in FIG. 2, the interrupt could be assigned to the CPUs of Cluster 0 for improved cache locality. Alternatively, the interrupt could be assigned to, for example, CPU2 (e.g., a selected target processor) of the power cores of FIG. 3 to prevent wear out.

As shown in FIG. 4, the process flow diagram 400 illustrates interrupt routing algorithms to target the interrupt on a specific package containing processors for processor hardware packaging and architecture aware interrupt routing. In this example, the processor hardware packaging and architecture aware interrupt routing considers the processors within a specific package in conjunction with existing mechanisms, including targeted interrupts considering a core's current idle state, efficiency class, or enabled/disabled state. In some implementations, the processor hardware packaging and architecture aware interrupt routing enables the interrupt controller 300 to scatter interrupts among the processors within a package.

As further illustrated in FIG. 4, at step 5, the interrupt routing mode is identified as 1:N routing. In response, at step 5.1, it is determined whether a core (e.g., Core<a>) is disabled. If the core (e.g., Core<a>) is disabled, at block 430, the core (e.g., Core<a>) is pushed out of a targeted processor list for the interrupt. Otherwise, at step 5.2, if efficiency class routing is enabled and the core (e.g., Core<b>) does not belong to a targeted efficiency class, the core (e.g., Core<b>) is pushed out of the target list for the interrupt at block 440.

At step 5.3, if the core (e.g., Core<c>) is in power-collapse mode and other cores are active, the core (e.g., Core<c>) is pushed out of the target list for the interrupt. According to various aspects of the present disclosure, when the core (e.g., Core<c>) is in power-collapse mode and other cores are in power-collapse mode, one of the collapsed cores in the package receives a wake-up request via the interrupt if package-based routing is enabled for the interrupt at block 420. At step 5.4, if the core (e.g., Core<d>) is in a transparent low power mode and other cores are active, the core (e.g., Core<d>) is pushed out of the target list. Otherwise, one of the cores in the package in the transparent low power mode is asserted for interrupt request (IRQ) processing if package-based routing is enabled for the IRQ at block 420. In this implementation, determining additional processors of a package including the one of N-cores is performed. This process includes issuing the shared peripheral interrupt to one or more of the additional processors, for example, a CPU of the power cores shown in FIG. 3.

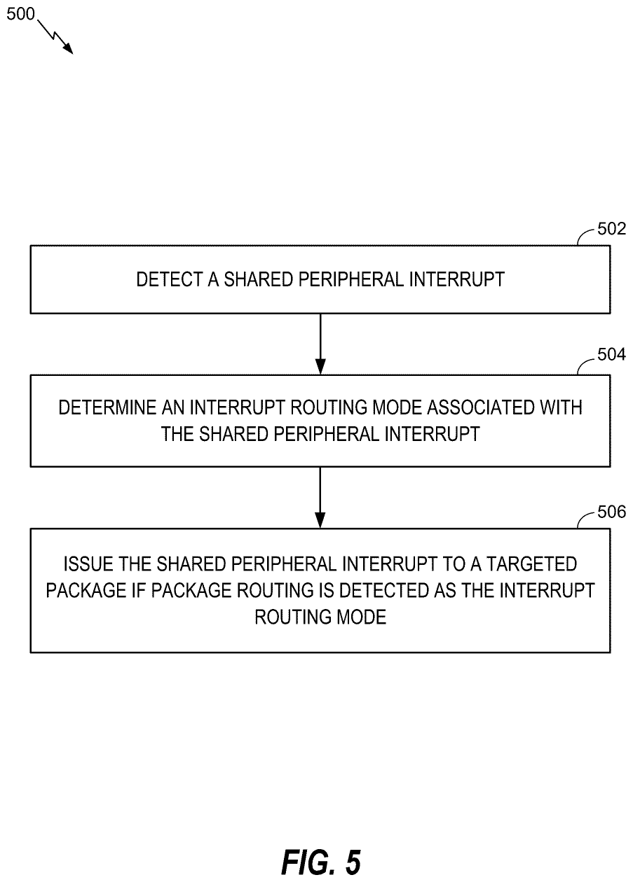

According to various aspects of the present disclosure, the processor hardware packaging and architecture aware interrupt routing improves an overall accuracy of interrupt routing algorithms to the applicable processor package with respect to reliability of the cores as well as efficiently utilizing cache locality for shared caches. Additionally, wide categories of interrupts specific to packages (e.g., package specific watchdogs, active dynamic voltage, and frequency scaling (DVFS) transition status, low power state indicators, targeted inter-process interrupts, package specific hardware intrusion prevention system (IPS) status, etc.) are delivered to cores within the package ensuring efficient and faster handling of interrupts in software and hardware. Providing interrupt migration at each execution level is more efficient with this implementation, which may be developed as an operating system agnostic solution utilizing firmware involvement. A method for processor hardware packaging and architecture aware interrupt routing may be performed, for example, as shown in FIG. 5.

FIG. 5 is a process flow diagram illustrating a method for processor hardware packaging and architecture aware interrupt routing, according to various aspects of the present disclosure. A method 500 begins at block 502, in which a shared peripheral interrupt is detected. For example, as shown in in the process flow diagram 400 of FIG. 4, steps 1-2 execute during device boot-up, in which package details for shared peripheral interrupts (SPIs) are updated for non-processor targeted interrupts. In various aspects of the present of the present disclosure, this process includes storing package configuration information for the SPIs in a configuration register space at boot-up. As shown at block 410, an SPI is generated.

At block 504, an interrupt routing mode associated with the shared peripheral interrupt is determined. For example, as shown in in the process flow diagram 400 of FIG. 4, at step 3, an interrupt routing mode of an issued SPI is generated as targeted routing. At block 412, a targeted core (Core<n>) manages the issued SPI. Otherwise, at step 4, the interrupt routing mode of the issued SPI is identified as package routing.

At block 506, the shared peripheral interrupt is issued to a targeted package if package routing is detected as the interrupt routing mode.

In some aspects, the method 500 may be performed by the host SoC 100 (FIG. 1). That is, each of the elements of method 500 may, for example, but without limitation, be performed by the host SoC 100 or one or more processors (e.g., multi-core CPU 102 and/or NPU 130) and/or other components included therein.

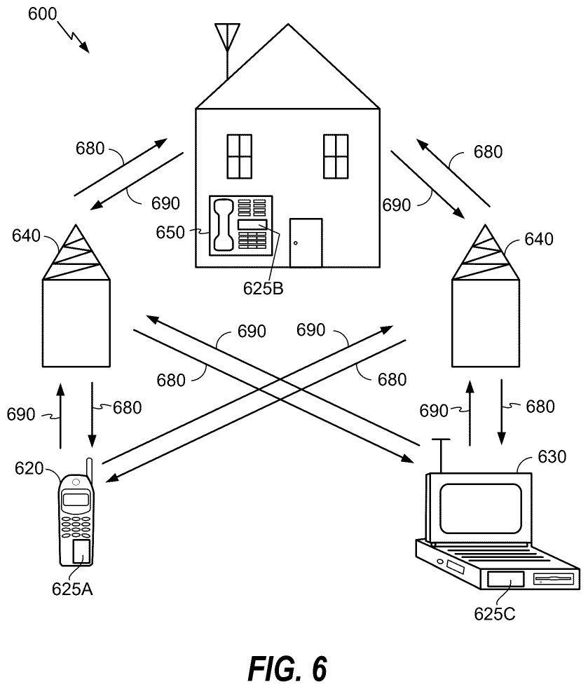

FIG. 6 is a block diagram showing an exemplary wireless communications system 600 in which an aspect of the disclosure may be advantageously employed. For purposes of illustration, FIG. 6 shows three remote units 620, 630, and 650, and two base stations 640. It will be recognized that wireless communications systems may have many more remote units and base stations. Remote units 620, 630, and 650 include IC devices 625A, 625B, and 625C that include the disclosed interrupt controller for processor hardware packaging and architecture aware interrupt routing. It will be recognized that other devices may also include the disclosed interrupt controller for processor hardware packaging and architecture aware interrupt routing, such as the base stations, switching devices, and network equipment. FIG. 6 shows forward link signals 680 from the base stations 640 to the remote units 620, 630, and 650, and reverse link signals 690 from the remote units 620, 630, and 650 to base stations 640.

In FIG. 6, remote unit 620 is shown as a mobile telephone, remote unit 630 is shown as a portable computer, and remote unit 650 is shown as a fixed location remote unit in a wireless local loop system. For example, the remote units may be a mobile phone, a hand-held personal communications systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 6 illustrates remote units according to aspects of the present disclosure, the disclosure is not limited to these exemplary illustrated units. Aspects of the present disclosure may be suitably employed in many devices, which include the disclosed interrupt controller for processor hardware packaging and architecture aware interrupt routing.

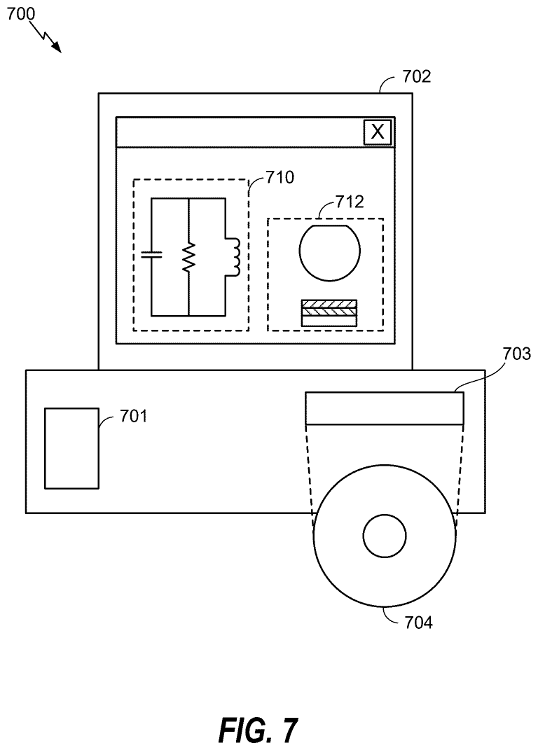

FIG. 7 is a block diagram illustrating a design workstation used for circuit, layout, and logic design of a semiconductor component, such as the processor hardware packaging and architecture aware interrupt routing disclosed above. A design workstation 700 includes a hard disk 701 containing operating system software, support files, and design software such as Cadence or OrCAD. The design workstation 700 also includes a display 702 to facilitate design of a circuit 710 or an integrated circuit (IC) component 712 such as the interrupt controller. A storage medium 704 is provided for tangibly storing the design of the circuit 710 or the IC component 712 (e.g., the interrupt controller for processor hardware packaging and architecture aware interrupt routing). The design of the circuit 710 or the IC component 712 may be stored on the storage medium 704 in a file format such as GDSII or GERBER. The storage medium 704 may be a CD-ROM, DVD, hard disk, flash memory, or other appropriate device. Furthermore, the design workstation 700 includes a drive apparatus 703 for accepting input from or writing output to the storage medium 704.

Data recorded on the storage medium 704 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 704 facilitates the design of the circuit 710 or the IC component 712 by decreasing the number of processes for designing semiconductor wafers.

Implementation examples are described in the following numbered clauses:
1. A method for processor hardware packaging and architecture aware interrupt routing, the method comprising:
   detecting a shared peripheral interrupt;
   determining an interrupt routing mode associated with the shared peripheral interrupt; and
   issuing the shared peripheral interrupt to a targeted package if package routing is detected as the interrupt routing mode.
2. The method of clause 1, further comprising storing package configuration information for the shared peripheral interrupts in a configuration register space at boot-up.
3. The method of any of clauses 1 or 2, in which determining the interrupt routing mode further comprises updating package details for the shared peripheral interrupt for non-processor targeted interrupts.
4. The method of any of clauses 1-3, in which issuing the shared peripheral interrupt comprises:
   selecting a target processor of the targeted package of the shared peripheral interrupt; and
   issuing the shared peripheral interrupt to the selected target processor of the targeted package.
5. The method of any of clauses 1-4, in which issuing the shared peripheral interrupt comprises dynamically issuing the shared peripheral interrupt between processors of the targeted package.
6. The method of clause 5, in which dynamically issuing the shared peripheral interrupt comprises randomly issuing the shared peripheral interrupt to the processors of the targeted package.
7. The method of clause 5, in which dynamically issuing the shared peripheral interrupt comprises issuing the shared peripheral interrupt to the processors of the targeted package according to a cache locality.
8. The method of any of clauses 1-7, further comprising issuing the shared peripheral interrupt to a targeted core if a targeted routing is detected as the interrupt routing mode.
9. The method of any of clauses 1-8, further comprising issuing the shared peripheral interrupt to one of N-cores if a 1:N routing is detected as the interrupt routing mode.
10. The method of clause 9, further comprising:
   determining additional processors of a package including the one of N-cores; and
   issuing the shared peripheral interrupt to one or more of the additional processors.
11. An apparatus, comprising:
   at least one memory; and
   at least one processor coupled to the at least one memory, the at least one processor configured to:
      detect a shared peripheral interrupt;
      determine an interrupt routing mode associated with the shared peripheral interrupt; and
      issue the shared peripheral interrupt to a targeted package if package routing is detected as the interrupt routing mode.
12. The apparatus of clause 11, in which the at least one processor is further configured to store package configuration information for the shared peripheral interrupts in a configuration register space at boot-up.
13. The apparatus of any of clauses 11 or 12, in which to determine the interrupt routing mode, the at least one processor is further to update package details for the shared peripheral interrupt for non-processor targeted interrupts.
14. The apparatus of any of clauses 11-13, in which to issue the shared peripheral interrupt, the at least one processor is further configure to:
   select a target processor of the targeted package of the shared peripheral interrupt; and
   issue the shared peripheral interrupt to the selected target processor of the targeted package.
15. The apparatus of any of clauses 11-14, in which to issue the shared peripheral interrupt, the at least one processor is further configured to dynamically issue the shared peripheral interrupt between processors of the targeted package.
16. The apparatus of clause 15, in which to dynamically issue the shared peripheral interrupt, the at least one processor is further configured to randomly issue the shared peripheral interrupt to the processors of the targeted package.
17. The apparatus of clause 15, in which to dynamically issue the shared peripheral interrupt, the at least one processor is further configured to issue the shared peripheral interrupt to the processors of the targeted package according to a cache locality.
18. The apparatus of any of clauses 11-17, in which the at least one processor further configured to issue the shared peripheral interrupt to a targeted core if a targeted routing is detected as the interrupt routing mode.
19. The apparatus of any of clauses 11-18, in which the at least one processor further configured to issue the shared peripheral interrupt to one of N-cores if a 1:N routing is detected as the interrupt routing mode.
20. The apparatus of clause 19, in which the at least one processor further configured to:
   determine additional processors of a package including the one of N-cores; and
   issue the shared peripheral interrupt to one or more of the additional processors.

For a firmware and/or software implementation, the methodologies may be implemented with modules (e.g., procedures, functions, etc.) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer. Disk and disc, as used herein, include compact disc (CD), laser disc, optical disc, digital versatile disc (DVD), floppy disk and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, various changes, substitutions, and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above, and below may refer to sides of a substrate or electronic device. Moreover, the scope of the present application is not intended to be limited to the configurations of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform the same function or achieve the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for processor hardware packaging and architecture aware interrupt routing, the method comprising:
detecting a shared peripheral interrupt;
determining an interrupt routing mode associated with the shared peripheral interrupt; and
issuing the shared peripheral interrupt to a targeted package if package routing is detected as the interrupt routing mode.

2. The method of claim 1, further comprising storing package configuration information for the shared peripheral interrupts in a configuration register space at boot-up.

3. The method of claim 1, in which determining the interrupt routing mode further comprises updating package details for the shared peripheral interrupt for non-processor targeted interrupts.

4. The method of claim 1, in which issuing the shared peripheral interrupt comprises:
selecting a target processor of the targeted package of the shared peripheral interrupt; and
issuing the shared peripheral interrupt to the selected target processor of the targeted package.

5. The method of claim 1, in which issuing the shared peripheral interrupt comprises dynamically issuing the shared peripheral interrupt between processors of the targeted package.

6. The method of claim 5, in which dynamically issuing the shared peripheral interrupt comprises randomly issuing the shared peripheral interrupt to the processors of the targeted package.

7. The method of claim 5, in which dynamically issuing the shared peripheral interrupt comprises issuing the shared peripheral interrupt to the processors of the targeted package according to a cache locality.

8. The method of claim 1, further comprising issuing the shared peripheral interrupt to a targeted core if a targeted routing is detected as the interrupt routing mode.

9. The method of claim 1, further comprising issuing the shared peripheral interrupt to one of N-cores if a 1:N routing is detected as the interrupt routing mode.

10. The method of claim 9, further comprising:
determining additional processors of a package including the one of N-cores; and
issuing the shared peripheral interrupt to one or more of the additional processors.

11. An apparatus, comprising:
at least one memory; and
at least one processor coupled to the at least one memory, the at least one processor configured to:
detect a shared peripheral interrupt;
determine an interrupt routing mode associated with the shared peripheral interrupt; and
issue the shared peripheral interrupt to a targeted package if package routing is detected as the interrupt routing mode.

12. The apparatus of claim 11, in which the at least one processor is further configured to store package configuration information for the shared peripheral interrupts in a configuration register space at boot-up.

13. The apparatus of claim 11, in which to determine the interrupt routing mode, the at least one processor is further to update package details for the shared peripheral interrupt for non-processor targeted interrupts.

14. The apparatus of claim 11, in which to issue the shared peripheral interrupt, the at least one processor is further configure to:
select a target processor of the targeted package of the shared peripheral interrupt; and
issue the shared peripheral interrupt to the selected target processor of the targeted package.

15. The apparatus of claim 11, in which to issue the shared peripheral interrupt, the at least one processor is further configured to dynamically issue the shared peripheral interrupt between processors of the targeted package.

16. The apparatus of claim 15, in which to dynamically issue the shared peripheral interrupt, the at least one processor is further configured to randomly issue the shared peripheral interrupt to the processors of the targeted package.

17. The apparatus of claim 15, in which to dynamically issue the shared peripheral interrupt, the at least one processor is further configured to issue the shared peripheral interrupt to the processors of the targeted package according to a cache locality.

18. The apparatus of claim 11, in which the at least one processor further configured to issue the shared peripheral interrupt to a targeted core if a targeted routing is detected as the interrupt routing mode.

19. The apparatus of claim 11, in which the at least one processor further configured to issue the shared peripheral interrupt to one of N-cores if a 1:N routing is detected as the interrupt routing mode.

20. The apparatus of claim 19, in which the at least one processor further configured to:
determine additional processors of a package including the one of N-cores; and
issue the shared peripheral interrupt to one or more of the additional processors.
